(19) United States
(12) Patent Application Publication
(10) Pub. No.: US 2026/0109571 A1
(43) Pub. Date: Apr. 23, 2026

(54) ELEVATOR SYSTEM COMPRISING AN ELEVATOR CAR TRACKING SYSTEM

(71) Applicant: Otis Elevator Company, Farmington, CT (US)

(72) Inventors: Pascal Rebillard, Gien (FR); Yingxin Gao, Farmington, CT (US); Gerard Sirigu, Gien (FR); Koji Kiyomoto, Tomisato-shi (JP); Antonio Martins, Vernon, CT (US)

(21) Appl. No.: 19/364,421

(22) Filed: Oct. 21, 2025

(30) Foreign Application Priority Data
Oct. 22, 2024 (EP) 24306778.2

(51) Int. Cl. B66B 1/50; B66B 1/34; B66B 1/40

(52) U.S. Cl. CPC B66B 1/50; B66B 1/3407; B66B 1/40

(57) ABSTRACT

An elevator system includes at least one elevator car configured for traveling along at least one guide member that extends in a hoistway between a plurality of landings; and an elevator car tracking system configured for determining and tracking the position of the at least one elevator car in the hoistway. The elevator car tracking system includes a first position detection system configured for detecting the position of the at least one elevator car with a first accuracy, the first position detection system configured for detecting the position of the at least one elevator car at every position in the hoistway that can be reached by the at least one elevator car; and a second position detection system configured for detecting the position of the at least one elevator car with a second accuracy that is more accurate than the first accuracy.

### FOREIGN PRIORITY

This application claims priority to European Patent Application No. 24306778.2, filed Oct. 22, 2024, and all the benefits accruing therefrom under 35 U.S.C. § 119, the contents of which in its entirety are herein incorporated by reference.

### TECHNICAL FIELD OF INVENTION

The invention relates to an elevator system comprising at least one elevator car and an elevator car tracking system that is configured for determining and tracking the position of the at least one elevator car in the hoistway. The invention is further related to a method of detecting and tracking the position of at least one elevator car that is configured for traveling between a plurality of landings of an elevator system.

### BACKGROUND OF THE INVENTION

An elevator system typically comprises at least one elevator car that is configured for moving along a hoistway extending between a plurality of landings. In order to allow for a safe and reliable operation of the elevator system, the position of the at least one elevator car in the hoistway should be reliably detected with sufficient accuracy.

It would therefore be beneficial to provide an elevator system with an elevator car tracking system that allows for reliably determining and tracking the position of the at least one elevator car in the hoistway and that may be implemented at low costs.

### SUMMARY OF THE INVENTION

An elevator system according to an exemplary embodiment of the invention comprises an elevator car that is configured for traveling along at least one guide member extending in a hoistway between a plurality of landings. The elevator system further comprises an elevator car tracking system that is configured for determining and tracking the position of the at least one elevator car in the hoistway. The elevator car tracking system includes a first position detection system that is configured for detecting the position of the at least one elevator car with a first accuracy. The elevator car tracking system further includes a second position detection system that is configured for detecting the position of the at least one elevator car with a second accuracy when a reference point that is defined at the at least one elevator car is located in a fine tracking zone that is defined in a vicinity of at least one of the landings. The second accuracy is more accurate than the first accuracy.

The reference point is defined at a predefined height of the elevator car. The reference point may, for example, be defined at the floor of the elevator car. Alternatively, the reference point may be defined at the top of the elevator car, for example at the height of a ceiling of the elevator car, or at a height between the floor and the top of the elevator car.

The first position detection system is configured for detecting the position of the at least one elevator car at least when the elevator car is located at positions that do not belong to a fine tracking zone. The first position detection system may in particular be configured for detecting the position of the at least one elevator car at every position in the hoistway that can be reached by the at least one elevator car.

Exemplary embodiments of the invention also include a method of detecting and tracking the position of at least one elevator car that is configured for traveling between a plurality of landings along at least one guide member in a hoistway of an elevator system. The method includes detecting and tracking the position of the at least one elevator car with a first accuracy; and detecting and tracking the position of the at least one elevator car with a second accuracy that is more accurate than the first accuracy when the reference point defined at the at least one elevator car is located in a fine tracking zone that is defined in the vicinity of at least one of the landings.

The method includes detecting the position of the at least one elevator car with the first accuracy at least when the reference point defined at the elevator car is located at positions that do not belong to a fine tracking zone. The method may in particular include detecting and tracking the position of the at least one elevator car with the first accuracy at every position in the hoistway that can be reached by the at least one elevator car.

The fine tracking zone may in particular extend from an upper position above the floor of the at least one landing to a lower position below the floor of the at least one landing. Alternatively, the fine tracking zone may extend from an upper position above a ceiling of the at least one landing to a lower position below the ceiling of the at least one landing.

In yet another configuration, the fine tracking zone may extend from an upper position to a lower position, wherein both positions are located between the ceiling and the floor of the at least one landing.

An elevator system and a method according to exemplary embodiments of the invention allow for reliably detecting the position of the at least one elevator car in the hoistway with an accuracy that is sufficient for securely and reliably operating the elevator system. An elevator system and a method according to exemplary embodiments of the invention allow in particular for detecting the position of the at least one elevator car with a high accuracy when the at least one elevator car is located in the vicinity of one of the landings. In consequence, the elevator car may be positioned with high accuracy at the respective landing, and the risk of forming a substantial step between the floor of the at least one elevator car and the respective landing, which may pose the risk of passengers tripping over said step when entering and leaving the at least one elevator car, may be considerably reduced.

When the at least one elevator car is not positioned in the vicinity of one of the landings, when the reference point defined at the at least one elevator car is in particular not positioned in a fine tracking zone, less accurate information on the position of the at least one elevator car is sufficient for reliably and safely controlling the movement of the at least one elevator car in the hoistway. In consequence, the less accurate positional information provided by the first position detection system is sufficient when the at least one elevator car is located in areas between the fine tracking zones.

An elevator system and a method according to exemplary embodiments of the invention combine the advantages of a first position detection system, in particular the reduced costs of such a first position detection system, with the advantages of a second position detection system that is capable of providing more accurate information on the position of the at least one elevator car when it is needed, in particular when the at least one elevator car is located in the vicinity of one of the landings.

In the following, a number of optional features of an elevator system according to exemplary embodiments of the invention are set out. These features may be realized in particular embodiments, alone or in combination with any of the other features, unless explicitly stated otherwise.

A respective fine tracking zone may be defined in the vicinity of several landings of the plurality of landings. In order to allow for positioning the at least one elevator car with high accuracy at each of the plurality of landings, respective fine tracking zones may in particular be defined in the vicinity of every landing of the plurality of landings of the elevator system.

The second position detection system may be configured for providing absolute positional information on the position of the at least one elevator car, in particular absolute positional information at least with respect to the respective landing.

The first position detection system may be configured for providing relative positional information on the position of the at least one elevator car.

The relative positional information may in particular provide information on the position of the at least one elevator car relatively to a previously detected absolute position of the at least one elevator car, more particularly relatively to an absolute position of the at least one elevator car that has been previously detected by the second position detection system.

A position detection system providing relative positional information may be less elaborate and less expensive than a position detection system that is configured for providing absolute positional information on the position of the at least one elevator car.

The elevator car tracking system may be configured for checking and/or for recalibrating the position of the at least one elevator car detected by the first position detection system with the first accuracy based on information on the position of the at least one elevator car that is provided by the second position detection system with the second accuracy when the reference point defined at the at least one elevator car is located in the at least one fine tracking zone.

The elevator car tracking system may in particular be configured for checking and/or for recalibrating the position of the at least one elevator car detected by the first position detection system with the first accuracy based on information on the position of the at least one elevator car provided by the second position detection system with the second accuracy whenever the reference point defined at the at least one elevator car is located in the at least one fine tracking zone.

Regularly checking and/or recalibrating the position of the at least one elevator car detected by the first position detection system based on information on the position of the at least one elevator car provided by the second position detection system may allow for preventing the positional information provided the first position detection system from drifting away from the positional information provided by the second position detection system over time. This may allow to ensure that the positional information provided by the second position detection system and the positional information provided by the first position detection system do not substantially deviate from each other within the limits of accuracy of the first position detection system.

The first position detection system may be configured for detecting the position of the at least one elevator car with a first accuracy of +/−15 mm or better, in particular with first accuracy of +/−10 mm or better, more particularly with a first accuracy of +/−5 mm or better.

The second position detection system may be configured for detecting the position of the at least one elevator car with a second accuracy of +/−5 mm or better, in particular with a second accuracy of +/−1 mm or better.

In an elevator car tracking system, the first position detection system may be configured for detecting the position of the at least one elevator car with a first accuracy of +/−10 mm or better, and the second position detection system may be configured for detecting the position of the at least one elevator car with a second accuracy of +/−5 mm or better.

Such limits of accuracy have been found to be sufficient and reasonable for safely operating the elevator system and for positioning the at least one elevator car with sufficiently good accuracy at the landings.

The fine tracking zones may have a length of 600 mm to 1000 mm along a longitudinal direction of the hoistway.

The fine tracking zones may be defined to extend from a lower boundary position that is 300 mm to 500 mm below the floor of the respective landing to an upper boundary position that is 300 mm to 500 mm above the floor of the respective landing.

Alternatively, the fine tracking zones may be defined to extend from a lower boundary position that is 300 mm to 500 mm below the ceiling of the respective landing to an upper boundary position that is 300 mm to 500 mm above the ceiling of the respective landing.

Fine tracking zones having these dimensions have been found as being sufficient and reasonable for safely operating the elevator system and for positioning the at least one elevator car with high accuracy at the landings.

The second position detection system may comprise at least one pattern of markers provided in the hoistway in or in the vicinity of each of the fine tracking zones. The second position detection system may further comprise a detector provided at the at least one elevator car and configured for detecting the markers of the at least one pattern of markers when the reference point defined at the at least one elevator car is located in a respective one of the fine tracking zones.

A combination of a pattern of markers provided at or in each of the fine tracking zones with a detector that is provided at the at least one elevator car and configured for detecting the markers allows for providing a reliable second position detection system that may be implemented at reasonable costs.

The at least one pattern of markers may be an optically detectable pattern of markers comprising a plurality of visual markers and/or a plurality of openings.

The at least one pattern of markers may also be a magnetically detectable pattern of markers comprising a plurality of magnetic markers/magnets.

The elevator system may comprise at least one landing door at each of the plurality of landings, and the at least one pattern of markers may be formed on or in the at least one landing door, in particular in a landing door panel of the at least one landing door. Alternatively, the at least one pattern of markers may be formed on or in a strip, in particular a metallic strip, that is mounted to the at least one landing door. The strip may be a perforated strip, in which a plurality of openings providing the optical markers is formed.

The at least one pattern of markers may be integrated into or mounted to the landing doors with high accuracy when the landing doors are produced in the factory. This facilitates and speeds up the installation of the elevator system in a building, as the markers do not need to be mounted, positioned and aligned individually in the hoistway when the elevator system is installed.

The second position detection system may comprise at least one marker that is provided in or in the vicinity of a respective one of the fine tracking zones; and a pattern of detectors that are arranged in a predefined pattern at the at least one elevator car. In such a configuration, the detectors are configured for detecting the at least one marker when the at least one elevator car is located next to the at least one marker.

The at least one marker may be a magnetic marker comprising at least one magnet, and the pattern of detectors may comprise a plurality of magnet detectors.

The first position detection system may comprise a velocity sensor that is attached to the at least one elevator car. The velocity sensor may comprise at least one wheel that is in frictional engagement with the at least one guide causing the at least one wheel to rotate when the at least one elevator car moves along the guide member. The velocity sensor may further comprise a rotational detector for detecting rotation of the at least one wheel. Such a configuration provides a reliable velocity detector that may be employed for detecting changes of the position of the at least one elevator car at reasonable costs.

In order to enhance the safety of the elevator system, the velocity detector may also be used for detecting any overspeeding of the at least one elevator car in order to allow for braking the movement of the at least one elevator car in case such overspeeding occurs.

For redundancy, the velocity detector may comprise two or more wheels.

The rotational detector may comprise at least one magnet attached to the at least one wheel for rotating concurrently with the at least one wheel. The rotational detector may further comprise at least one magnet detector, in particular a tunnel magnetoresistance detector, that is configured for detecting the revolutions of the at least one wheel by detecting the at least one magnet passing by the at least one magnet detector when the at least one wheel rotates while moving along the guide member. Such a combination of at least one magnet and at least one magnet detector allows for providing a very reliable velocity detector.

The resolution of the velocity detector may be increased by attaching a plurality of magnets to each of the wheels, respectively.

Alternatively or additionally, the first position detection system may comprise an optical sensor that is attached to the at least one elevator car and configured for optically detecting movement of the at least one elevator car with respect to the at least one guide member. The optical sensor may be constructed similar to an optical computer mouse: It may comprise a light source, in particular a laser light source, that is configured for emitting a light beam, in particular a laser light beam, onto the at least one guide member. The optical sensor may further comprise a light detector that is configured for detecting light that is reflected by the at least one guide member and for providing a corresponding light detection signal; and an analyzer that is configured for analyzing the light detection signal provided by the at least one light detector for determining changes of the position of the optical sensor with respect to the guide member.

Such an optical sensor, which may be manufactured and installed in an elevator system at reasonable costs, may provide a reliable sensor for detecting movements of the at least one elevator car with respect to the at least one guide member.

Alternatively or additionally, the first position detection system may comprise an acceleration sensor/accelerometer that is attached to the at least one elevator car and configured for detecting any accelerations of the at least one elevator car. The acceleration sensor/accelerometer may in particular be or comprise an inertia sensor. Changes of the position of the at least one elevator car may be determined by integrating the detected accelerations of the at least one elevator car twice over time. Such an acceleration detector/accelerometer further allows for determining the velocity of the at least one elevator car by integrating the detected accelerations once of time. This may be employed for detecting any overspeeding of the at least one elevator car.

The first position detection system of an elevator system according to an exemplary embodiment of the invention may comprise one of the detectors mentioned before for determining a relative position of the at least one elevator car in the hoistway. In order to enhance the reliability and the safety of the elevator system, the first position detection system may in particular comprise a combination of at least two of the above mentioned detectors.

In an elevator system according to an exemplary embodiment of the invention, at least one RFID tag may be provided in the hoistway at at least one of the landings. Further, at least one RFID reader that is configured for reading information comprised in the at least one RFID tag may be provided at the at least one elevator car.

The at least one RFID tag may comprise information on the respective landing, such as the number of the floor at which the respective landing is located and/or information on facilities and/or companies located on the respective floor.

Information stored in the RFID tag may be read by the at least one RFID reader when it passes the at least one RFID tag or when it is located next to the at least one RFID tag.

The information read from the RFID tag may be displayed or announced to passengers in the at least one elevator car. Alternatively and/or additionally, the information read from the at least one RFID tag may be used for checking and for confirming the positional information provided by the elevator car tracking system. The information stored in the RFID tag may in particular comprise the information that the at least one elevator car is located at a specific landing, which may, for example, be identified by a number and/or at least one character that is stored in the at least one RFID tag and that unambiguously identifies the respective landing.

RFID tags may be provided at several landings, in particular at every landing of the elevator system.

The additional features, modifications and effects that have been described with respect to elevator systems comprising a passenger detection system according to exemplary embodiments of the invention apply to the above mentioned method of detecting and tracking the position of the at least one elevator car in an elevator system in an analogous manner.

### BRIEF DESCRIPTION OF THE DRAWINGS

In the following, exemplary embodiments of the invention are described in more detail with respect to the enclosed figures:

FIG. 1 depicts a schematic view of an elevator system according to an exemplary embodiment of the invention.

FIG. 2A depicts a velocity sensor that may be attached to the elevator car.

FIG. 2B depicts an enlarged view of a wheel of the velocity sensor depicted in FIG. 2A.

FIG. 3A depicts an optical sensor that is attached to the top of the elevator car.

FIG. 3B is a schematic view illustrating the operating principle of the optical sensor depicted in FIG. 3A.

FIG. 4 depicts an exemplary embodiment of a second position detection system comprising a pattern of optical markers.

FIG. 5 depicts an exemplary embodiment of a second position detection system comprising a pattern of magnet detectors.

### DETAILED DESCRIPTION OF THE INVENTION

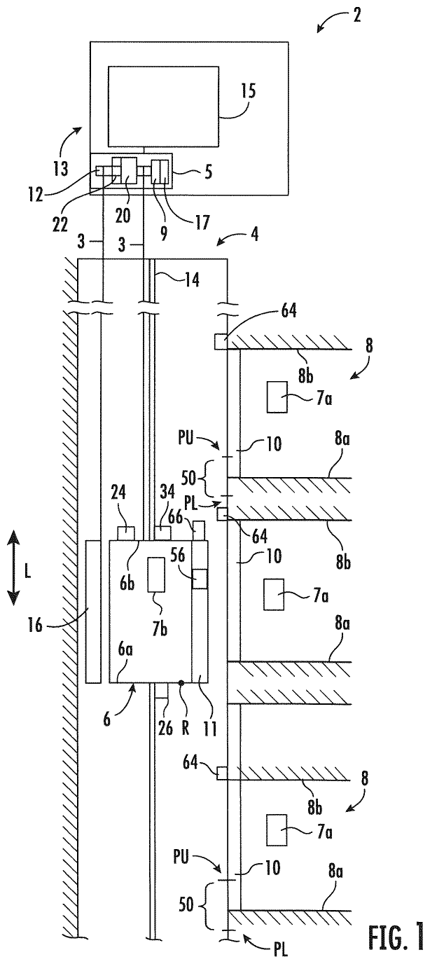

FIG. 1 schematically depicts an elevator system 2 according to an exemplary embodiment of the invention.

The elevator system 2 comprises a hoistway 4 extending in a longitudinal direction L between a plurality of landings 8 located on different floors. The elevator system 2 includes an elevator car 6 that is arranged in the hoistway 4 for being moved along the longitudinal direction L between the plurality of landings 8. The elevator car 6 may in particular be movable along at least one elevator car guide member 14, such as at least one elevator car guide rail, provided in the hoistway 4 and extending along the longitudinal direction L.

The longitudinal direction L may be oriented in a vertical direction, as it is depicted in FIG. 1. In an alternative embodiment that is not depicted in the figures, the longitudinal direction L may be inclined with respect to the vertical direction.

Although only a single elevator car guide member 14 is depicted in FIG. 1, the elevator system 2 may comprise a plurality of elevator car guide members 14 extending parallel to each other.

Although only a single elevator car 6 is depicted in FIG. 1, exemplary embodiments of the invention may also include elevator systems 2 comprising a plurality of elevator cars 6 moving in one or more hoistways 4.

The elevator car 6 is movably suspended by means of a tension member 3. Although only a single tension member 3 is depicted in FIG. 1, exemplary embodiments of the invention may also include elevator systems 2 comprising a plurality of tension members 3.

The at least one tension member 3, for example a rope or belt, is coupled to an elevator drive system 5. The elevator drive system 5 comprises a motor 9 for rotatably driving a shaft 12, and a drive 17 that harnesses and controls the electrical energy supplied to the motor 9. The elevator drive system 5 is configured for driving the at least one tension member 3, which is coupled to the shaft 12 via traction, in order to move the elevator car 6 in the hoistway 4 along the longitudinal direction L between the plurality of landings 8.

The elevator drive system 5 is further provided with at least one elevator brake 20 for braking rotation of the shaft 12 in order to allow for stopping movement of the elevator car 6 and holding the elevator car 6 at a desired position in the hoistway 4.

Optionally, the elevator system 2 may comprise an elevator counterweight 16. The elevator counterweight 16 may be attached to the at least one tension member 3 opposite to the elevator car 6 and configured for moving concurrently and in opposite direction with respect to the elevator car 6. The elevator counterweight may move along at least one elevator counterweight guide member, which is not shown in FIG. 1.

The at least one tension member 3 may be a rope, e.g. a steel cord, or a belt, in particular a coated steel belt. The at least one tension member 3 may be uncoated. Alternatively, the at least one tension member 3 may be coated with a coating, e.g. with a coating having the form of a polymer jacket. In a particular embodiment, the at least one tension member 3 may be a belt comprising a plurality of polymer coated steel cords (not shown). The elevator system 2 may have a traction drive including a traction sheave for driving the at least one tension member 3.

In the exemplary embodiment shown in FIG. 1, a 1:1 roping is employed for suspending the elevator car 6. The type of the roping is, however, not essential for the invention and different kinds of roping, e.g. a 2:1 roping or a 4:1 roping may be employed as well.

A landing door 10 is provided at each of the landings 8. The elevator car 6 is provided with a corresponding elevator car door 11 for allowing passengers to transfer between a landing 8 and the interior of the elevator car 6, when the elevator car 6 is positioned at the respective landing 8.

For moving the elevator car 6 along the hoistway 4 between the different landings 8, the elevator drive system 5 may be controlled by an elevator controller 15 of the elevator system 2.

The elevator system 2 may be a machine room-less elevator system 2. In an alternative embodiment, the elevator system 2 may comprise a machine room 13 housing the elevator drive system 5 and the elevator controller 15.

Input to the elevator controller 15 may be provided via landing control panels 7a provided on every landing 8, in particular in the vicinity of the landing doors 10, and/or via an elevator car control panel 7b provided inside the elevator car 6.

The landing control panels 7a may comprise elevator hall call buttons and/or destination call buttons. Destination call buttons allow passengers to enter their respective destinations before entering the elevator car 6. In case the landing control panels 7a are equipped with destination call buttons, no elevator car control panel 7b needs to be provided inside the elevator car 6 since the elevator system 2 is fully controlled by the commands input via the landing control panels 7a.

The landing control panels 7a and the elevator car control panel 7b may be coupled with the elevator controller 15 by means of electrical wiring not shown in FIG. 1, in particular by an electric bus, or by wireless data connections.

The elevator system 2 depicted in FIG. 1 is equipped with an elevator car tracking system that is configured for determining and tracking the position of the elevator car 6 in the hoistway 4.

The elevator car tracking system includes a first position detection system and a second position detection system. The first position detection system is configured for detecting the position of the elevator car 6 with a first accuracy. The second position detection system is configured for detecting the position of the elevator car with a second accuracy that is more accurate than the first accuracy.

A reference point R is defined at the elevator car 6. In the exemplary embodiment depicted in FIG. 1, the reference point R is defined at the floor 6a of the elevator car 6.

In alternative embodiments, the reference point R may be defined at the top of the elevator car 6, in particular at the ceiling 6b of the elevator car 6, or at a position between the floor 6a and the top of the elevator car 6.

The first position detection system is configured for detecting the position of the at least one elevator car 6 at least in situations in which the reference point R of the elevator car 6 is located at positions that do not belong to one of a plurality of fine tracking zones 50. The first position detection system may in particular be configured for detecting the position of the elevator car 6 at every position in the hoistway 4 that can be reached by the elevator car 6.

The second position detection system is configured for detecting the position of the elevator car 6 only when the reference point R of the elevator car 6 is located in one of a plurality of fine tracking zones 50 that are defined next to the landings 8.

In the elevator system 2 depicted in FIG. 1, a fine tracking zone 50 is defined at every depicted landing 8.

Each fine tracking zone 50 extends between an upper boundary position PU located above the floor 8a of respective landing 8 and a lower boundary position PL located below the floor 8a of respective landing 8.

The upper boundary position PU may, for example, be located 300 mm to 500 mm above the floor 8a of respective landing 8, and the lower boundary position PL may, for example, be located 300 mm to 500 mm below the floor 8a of respective landing 8. However, depending on the operational parameters of the elevator system 2, other dimensions of the fine tracking zones 50 are possible as well.

In embodiments in which the reference point R is defined at the top of the elevator car 6, the upper boundary position PU and the lower boundary position PL may be defined with respect to the ceiling 8b of the respective landing 8.

In embodiments in which the reference point R is defined at a position between the floor 6a and the top of the elevator car 6, the upper boundary position PU and the lower boundary position PL may be defined at a position in the hoistway 4 that is located between floor 8a of respective landing 8 and the ceiling 8b of the respective landing 8.

The first position detection system may comprise an encoder 22 that is provided at the elevator drive system 5 and configured for detecting rotation of the shaft 12 of the elevator drive system 5. Detecting rotation of the shaft 12 of the elevator drive system 5 allows for determining changes of the position of the elevator car 6 in the hoistway 4.

Alternatively or additionally, the first position detection system may comprise an acceleration sensor 24 attached to the elevator car 6. The acceleration sensor 24 may be or may comprise an inertia sensor or accelerometer. Detecting accelerations of the elevator car 6 and integrating the detected accelerations twice over time allows for determining changes of the position of the elevator car 6 in the hoistway 4.

Alternatively or additionally, the first position detection system may comprise a velocity sensor 26 that is attached to the elevator car 6. Detecting the velocity of the elevator car 6 and integrating the detected velocity once over time allows for determining changes of the position of the elevator car 6 in the hoistway 4.

Further features of the exemplary embodiment of an elevator system 2 depicted in FIG. 1 that have not been mentioned yet will be described further below.

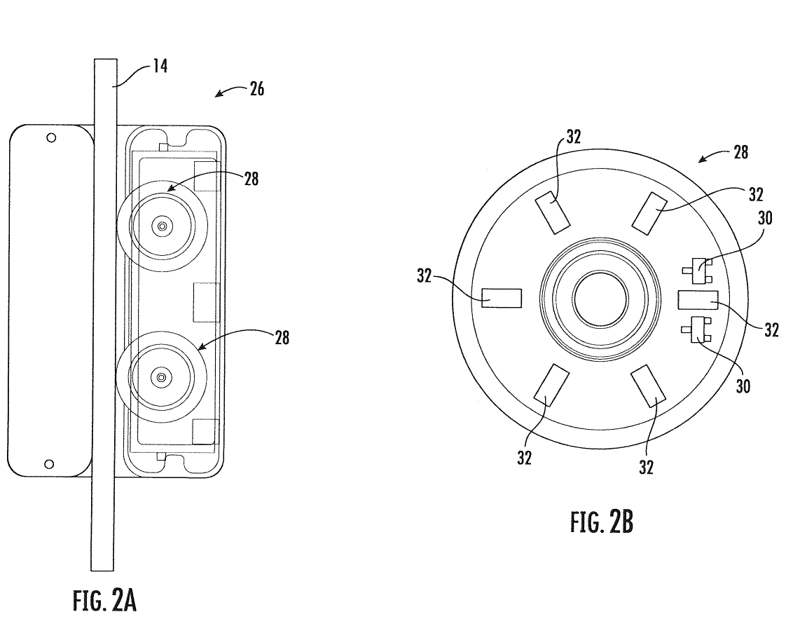

FIG. 2A depicts an exemplary embodiment of a velocity sensor 26 that may be attached to the elevator car 6.

The velocity sensor 26 depicted in FIG. 2A comprises two wheels 28 that are in frictional engagement with the at least one guide member 14. This causes the wheels 28 to rotate when the elevator car 6 moves along the guide member 14.

In an alternative embodiment that is not depicted in the figures, the velocity sensor 26 may comprise only a single wheel 28. In the embodiment depicted in FIG. 2A, an additional wheel 28 is provided for increasing the operational reliability of the velocity sensor 26 due to redundancy.

FIG. 2B depicts an enlarged view of one of the wheels 28 of the velocity sensor 26 depicted in FIG. 2A.

A plurality of magnets 32 is attached to the wheel 28 and two magnet detectors 30, in particular two tunnel magnetoresistance detectors (“TMR detectors”) 30, are provided next to the wheel 28 in a configuration in which they do not rotate together with the wheel 28. Each of the magnet detectors 30 detects a rotation of the wheel 28 by detecting the magnets 32 successively passing by the respective magnet detector 30 when the wheel 28 rotates. The magnet detectors 30 and the magnets 32 constitute a rotational detector that allows for detecting any movement of the elevator car 6 along the guide member 14 with sufficiently good accuracy.

A single magnet detector 30 may be sufficient for detecting rotation of the wheel 28. The exemplary embodiment depicted in FIG. 2B comprises two magnet detectors 30 for enhancing the reliability of the velocity sensor 26 due to redundancy.

Alternatively or additionally, the first position detection system may comprise an optical sensor 34 that is attached to the elevator car 6 and configured for optically detecting any movement of the elevator car 6 with respect to the at least one guide member 14.

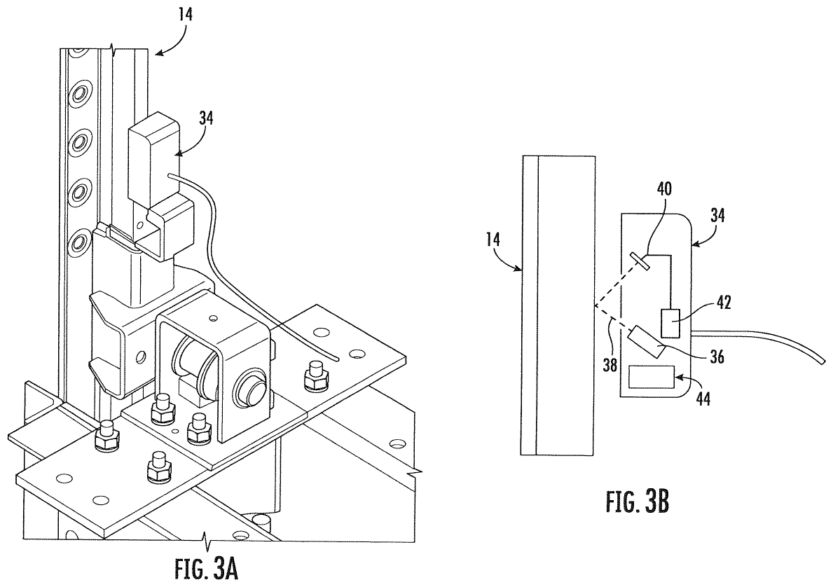

FIG. 3A depicts such an optical sensor 34 attached to the top of the elevator car 6.

The operating principle of the optical sensor 34 is schematically illustrated in FIG. 3B.

The optical sensor 34 comprises at least one light source 36, in particular at least one laser light source 36, such as a laser diode, that is configured for emitting a light beam 38, in particular a laser light beam 38, onto the at least one guide member 14. The optical sensor 34 further comprises at least one light detector 40 that is configured for detecting light from the light beam 38 that has been reflected by the at least one guide member 14 and for outputting a corresponding light detection signal.

The optical sensor 34 comprises an analyzer 42 that is configured for determining changes of the position of the optical sensor 34 with respect to the guide member 14 by analyzing the light detection signal provided by the at least one light detector 40. For detecting movements of the optical sensor 34 along the least one guide member 14, the analyzer 42 may be configured for recognizing changes of the surface structure along the longitudinal extension of the at least one guide member 14 when the optical sensor 34 moves in the longitudinal direction L along the optical sensor 34. The optical sensor 34 may in particular operate similar to an optical computer mouse that is configured for optically detecting movements of the optical computer mouse with respect to a base, such as the surface of a table or a mouse pad.

The optical sensor 34 may comprise a battery 44 supplying electrical power for operating the optical sensor 34. Alternatively or additionally, the optical sensor 34 may be supplied with electric power from the elevator system 2 via electric wires.

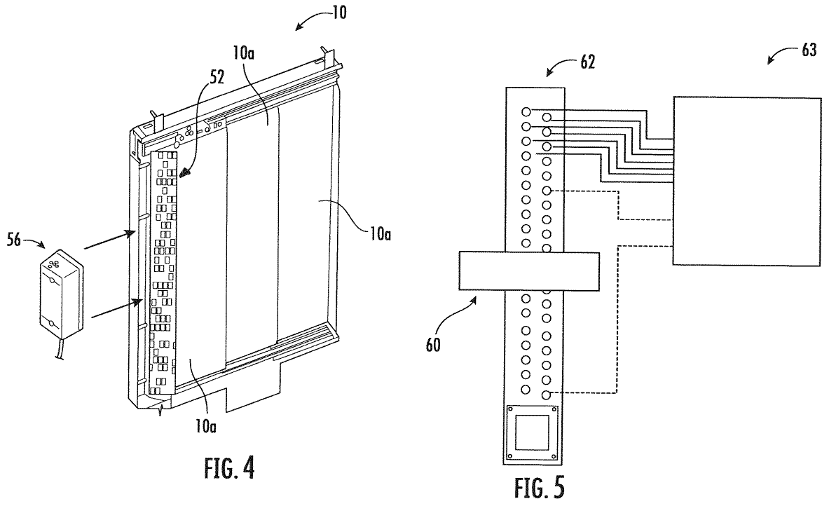

An exemplary embodiment of a second position detection system is schematically illustrated in FIG. 4.

In the embodiment depicted in FIG. 4, the second position detection system comprises a pattern of optical markers 52 provided in the hoistway 4 in or in the vicinity of each of the fine tracking zones 50. The pattern of optical markers 52 may in particular be provided at the landing doors 10 of the respective landing 8.

The optical markers 52 may be provided on a carrier. The optical markers 52 may also be openings that are formed in the carrier.

The carrier may be a strip, in particular a metallic strip, that is attached to the frame or to one of the landing door panels 10a of the landing doors 10. The strip may be a perforated strip, in which a pattern of openings providing the optical markers 52 is formed.

In an alternative embodiment, the optical markers 52 themselves may be attached to or formed in the frame or in the door panels 10a of the landing doors 10.

Forming the optical markers 52 on or in the frame or in a door panel 10a of a landing door 10 allows for installing the optical markers 52 with high accuracy in the factory when the frame or to the door panels 10a of the landing doors 10 are manufactured. When the optical markers 52 are installed in the factory, it is not necessary to add and calibrate the optical markers 52 on site in the hoistway 4 when the elevator system 2 is installed. As a result, the installation of the elevator system 2 on site may be simplified and accelerated. In addition, the risk of mounting the optical markers 52 erroneously may be reduced.

The second position detection system may further comprise an optical detector 56 that is provided at the elevator car 6 and that is configured for detecting the at least one pattern of optical markers 52 when the reference point R defined at the elevator car 6 is located in a fine tracking zone 50.

The vertical position of the pattern of optical markers 52 depends on the vertical position optical detector 56 at the elevator car 6. When the detector 56 is arranged at the same height as the reference point R, the pattern of optical markers 52 may in particular be arranged in the hoistway 4 between the upper boundary position PU and the lower boundary position PL.

The pattern of optical markers 52 may be arranged at a different vertical position in the hoistway 4, when the detector 56 is not arranged at the same height as the reference point R, as in the exemplary embodiment depicted in FIG. 1.

he information provided by the optical detector 56 allows the elevator system 2, in particular the elevator controller 15, to determine the position of the elevator car 6 in the hoistway 4 with the second accuracy, when the elevator car 6 is positioned in one of the fine tracking zones 50.

In another embodiment, the second tracking system may comprise a pattern of permanent magnets providing magnetic markers that are arranged in a predefined pattern in each of the fine tracking zones 50. In this case, the detector may be a magnetic detector configured for detecting the pattern of magnetic markers in order to allow determining the position of the elevator car 6 in the hoistway 4 with the second accuracy, when the elevator car 6 is positioned in one of the fine tracking zones 50.

In yet another embodiment that is schematically depicted in FIG. 5, the second position detection system comprises at least one marker 60, in particular at least one magnetic marker 60, that is provided at a predefined position in or in the vicinity of the fine tracking zones 50 at the respective landing 8. The at least one marker 60 may, for example, be located at the sill and/or at an upper guide rail of the landing door 10 at the respective landing 8.

The second position detection system further comprises a pattern of detectors 62, in particular a pattern of magnet detectors 62, provided at the elevator car 6, wherein the detectors 62 are configured for detecting the at least one marker 60.

The vertical position of the at least one marker 60 in the hoistway 4 depends on the vertical position of the detectors 62 at the elevator car 6. When the detectors 62 are arranged next to the reference point R, the at least one marker 60 may in particular be arranged between the upper boundary position PU and the lower boundary position PL.

The at least one marker 60 may be arranged at a different vertical position in the hoistway 4, when the detectors 62 are arranged at a different height than the reference point R.

When the reference point R of the elevator car 6 is located in one of the fine tracking zones 50, the at least one marker 60 is detected by at least one of the detectors 62, in particular by a plurality of the detectors 62. As a result, the plurality of the detectors 62 provide a pattern of signals that is characteristic for the position of the elevator car 6 with respect to the at least one marker 60. Thus, an evaluation circuit 63 receiving the signals provided by the plurality of the detectors 62 may determine the position of the elevator car 6 in the hoistway 4 based on the received signals. The evaluation circuit 63 may be part of the elevator controller 15 or of the second position detection system.

As mentioned before, the second position detection system is configured for detecting and providing information on the position of the elevator car 6 in the hoistway 4 with a second accuracy that is more accurate than the first accuracy of the information on the position of the elevator car 6 that is provided by the first detection system.

The first position detection system may, for example, be configured for detecting the position of the elevator car 6 in the hoistway 4 with a first accuracy +/−15 mm or better, in particular with first accuracy of +/−10 mm or better, more particularly with a first accuracy of +/−5 mm or better.

When the elevator car 6 is positioned in intermediate sections of the hoistway 4 between adjacent landings 8, such coarse information on the position of the elevator car 6 is sufficient for reliably and safely controlling the movement of the elevator car 6.

The second position detection system may, for example, be configured for detecting the position of the elevator car 6 with respect to an adjacent landing 8 with a second accuracy of +/−5 mm or better, in particular with second accuracy of +/−1 mm or better.

Since the second position detection system is configured for providing very accurate information on the position of the elevator car 6 when the reference point R defined at the elevator car 6 is located in one of the fine tracking zones 50 in the vicinity of the landings 8, the accurate information provided by the second position detection system allows for positioning the elevator car 6 with high accuracy at the respective landing 8. This allows for minimizing differences in height between the floor of the elevator car 6 and the floor of the respective landing 8. In consequence, the risk of forming a substantial step between the floor of the elevator car 6 and the respective landing 8, which may pose the risk of passengers tripping over said step when entering and leaving the elevator car 6, may be considerably reduced.

A second position detection system as it has been described before provides absolute positional information on the position of the elevator car 6 with respect to the respective landing 8. A first position detection system as it has been described before provides relative positional information on the position of the elevator car 6. In other words, the exemplary embodiments of first position detection systems described before provide information on the difference between the current position of the elevator car 6 and a previously known absolute position of the elevator car 6, in particular an absolute position at one of the landings 8 that has been determined by the second position detection system.

The elevator car tracking system may be configured for checking and/or for recalibrating the position of the elevator car 6 that has been detected by the first position detection system based on information on the current position of the elevator car 6 that is provided by the second position detection system with the second accuracy when the elevator car 6 is located in one of the fine tracking zones 50.

The elevator car tracking system may be configured for checking and/or for recalibrating the position of the elevator car 6 that has been detected by the first position detection system based on information on the absolute position of the elevator car 6 that is provided by the second position detection system with the second accuracy every time the elevator car 6 is located in one of the fine tracking zones 50. Alternatively, the elevator car tracking system may be configured for checking and/or for recalibrating the position of the elevator car 6 in predefined time intervals and/or after a predefined number of operations/movements of the elevator car 6.

By checking and/or recalibrating the relative information on the position of the elevator car 6 provided by the first position detection system based on absolute information on the position of the elevator car 6 provided by the second position detection system, it is possible to prevent that the difference between the position of the elevator car 6 reported by the first position detection system and the actual position of the elevator car 6 in the hoistway 4 increases over time, which would result in very inaccurate and unreliable positional information provided by the first position detection system.

Optionally, one or more RFID tags 64 may be provided in the hoistway 4. An RFID tag 64 may, for example, be installed at at least one of the landings 8, more particularly at the sill of at least one of the landings 8. Optionally, RFID tags 64 may be provided at several landings 8, in particular at every landing 8 of the elevator system 2.

The elevator car 6 may be equipped with an RFID reader 66 that is configured for reading information stored in the RFID tag 64.

The information stored in the RFID tag 64 may, for example, include information on the respective landing 8, e.g. the number of the floor at which the respective landing 8 is located and/or information on facilities and/or companies that are located on the respective floor.

The information stored in the RFID tag 64 may be read by the at least one RFID reader 66 when it passes the at least one RFID tag 64 and/or when it is located next to the at least one RFID tag 64.

The information read from the RFID tag 64 may be displayed and/or announced to passengers in the elevator car 6. Alternatively and/or additionally, the information read from the at least one RFID tag 64 may be used for checking and confirming the information on the position of the elevator car 6 provided by the elevator car tracking system, in particular the information that the elevator car 6 is located at a specific landing 8.

While the invention has been described with reference to exemplary embodiments, it will be understood by those skilled in the art that various changes may be made and equivalents may be substituted for elements thereof without departing from the scope of the invention. In addition, many modifications may be made to adopt a particular situation or material to the teachings of the invention without departing from the essential scope thereof. Therefore, it is intended that the invention shall not be limited to the particular embodiment disclosed, but that the invention includes all embodiments falling in the scope of the dependent claims.

What is claimed is:

1. An elevator system (2) comprising:
at least one elevator car (6) configured for traveling along at least one guide member (14) that extends in a hoistway (4) between a plurality of landings (8); and
an elevator car tracking system configured for determining and tracking the position of the at least one elevator car (6) in the hoistway (4);
the elevator car tracking system comprising:
a first position detection system configured for detecting the position of the at least one elevator car (6) with a first accuracy, wherein the first position detection system is in particular configured for detecting the position of the at least one elevator car (6) in the hoistway (4); and
a second position detection system configured for detecting the position of the at least one elevator car (6) with a second accuracy that is more accurate than the first accuracy when a reference point (R) that is defined at the at least one elevator car (6) is located in a fine tracking zone (50) that is defined in a vicinity of at least one of the landings (8)
wherein the first position detection system is configured for detecting the position of the at least one elevator car (6) at least when the reference point (R) defined at the at least one elevator car (6) is not located in a fine tracking zone (50).

2. The elevator system (2) according to claim 1, wherein a respective fine tracking zone (50) is defined in a vicinity of several landings (8) of the plurality of landings (8), respectively, wherein a respective fine tracking zone (50) is in particular defined in a vicinity of every landing (8) of the plurality of landings (8), respectively.

3. The elevator system (2) according to claim 1, wherein the second position detection system is configured for providing absolute positional information on the position of the at least one elevator car (6) at least with respect to the respective landing (8); and/or wherein the first position detection system is configured for providing relative positional information on the position of the at least one elevator car (6).

4. The elevator system (2) according to claim 1, wherein the elevator car tracking system is configured for checking and/or for recalibrating the position of the at least one elevator car (6) detected by the first position detection system with the first accuracy based on information on the position of the at least one elevator car (6) provided by the second position detection system with the second accuracy when the reference point (R) defined at the at least one elevator car (6) is located in the at least one fine tracking zone (50).

5. The elevator system (2) according to claim 1,
wherein the first position detection system is configured for detecting the position of the at least one elevator car (6) with a first accuracy of +/−15 mm or better, in particular with first accuracy of +/−10 mm or better, more particularly with a first accuracy of +/−5 mm or better; and/or
wherein the second position detection system is configured for detecting the position of the at least one elevator car (6) with a second accuracy of +/−5 mm or better, in particular with second accuracy of +/−1 mm or better; and/or
wherein each of the fine tracking zones (50) is defined to extend from a lower boundary position (PL) that is 300 mm to 500 mm below a floor (8a) of the respective landing (8) to an upper boundary position (PU) that is 300 mm to 500 mm above the floor (8a) of the respective landing (8); or
wherein each of the fine tracking zones (50) is defined to extend from a lower boundary position (PL) that is 300 mm to 500 mm below a ceiling (8b) of the respective landing (8) to an upper boundary position (PU) that is 300 mm to 500 mm above the ceiling (8b) of the respective landing (8).

6. The elevator system (2) according to claim 1, wherein the second position detection system comprises:
at least one pattern of markers (52) provided in the hoistway (4) in or in the vicinity of each of the fine tracking zones (50); and
a detector (56) provided at the at least one elevator car (6) and configured for detecting the markers (52) of the at least one pattern of markers (52) when the reference point (R) of the at least one elevator car (6) is located in a respective one of the fine tracking zones (50);
wherein the at least one pattern of markers (52) is in particular an optically detectable pattern of markers (52) comprising a plurality of visual markers (52) and/or a plurality of openings, and/or wherein the at least one pattern of markers (52) is in particular a magnetically detectable pattern of markers (52) comprising a plurality of magnetic markers (52).

7. The elevator system (2) according to claim 6,
wherein the elevator system (2) comprises at least one landing door (10) at each of the plurality of landings (8),
wherein the at least one pattern of markers (52) is formed on or in the at least one landing door (10), in particular in a landing door panel (10a) of the at least one landing door (10); and/or wherein the at least one pattern of markers (52) is formed on or in a strip, in particular a metallic strip, mounted to the at least one landing door (10).

8. The elevator system (2) according to claim 1, wherein the second position detection system comprises:
at least one marker (60) provided in or in the vicinity of a respective one of the fine tracking zones (50); and
a pattern of detectors (62) provided at the at least one elevator car (6) and configured for detecting the at least one marker (60) when the reference point (R) of the at least one elevator car (6) is located in the respective fine tracking zone (50);
wherein the at least one marker (60) is in particular a magnetic marker (60), and wherein the pattern of detectors (62) comprises in particular a plurality of magnet detectors (62).

9. The elevator system (2) according to claim 1, wherein the first position detection system comprises:
a velocity sensor (26) attached to the at least one elevator car (6) and comprising:
at least one wheel (28) that is in frictional engagement with the at least one guide member (14) such as to rotate when the at least one elevator car (6) moves along the guide member (14), and
a rotational detector (32, 33) for detecting rotation of the at least one wheel (28).

10. The elevator system (2) according to claim 9,
wherein the rotational detector (30, 32) comprises at least one magnet (30) and at least one tunnel magnetoresistance detector (30) for detecting the revolutions of the at least one wheel (28) when the at least one wheel (28) rotates along the guide member (14).

11. The elevator system (2) according to claim 1,
wherein the first position detection system comprises an optical sensor (34) attached to the at least one elevator car (6) and configured for optically detecting movement of the at least one elevator car (6) with respect to the at least one guide member (14);
wherein the optical sensor (34) comprises in particular:
a light source (36), in particular a laser light source (36) that is configured for emitting a light beam (38), in particular a laser light beam (38), onto the at least one guide member (14); and
a light detector (40) that is configured for detecting light that is reflected by the at least one guide member (14).

12. The elevator system (2) according to claim 1,
wherein the first position detection system comprises an acceleration sensor (24) that is attached to the at least one elevator car (6) and configured for detecting an acceleration of the at least one elevator car (6);
wherein the first position detection system is configured for determining a relative position of the at least one elevator car (6) by integrating the acceleration of the at least one elevator car (6) detected by the acceleration sensor (24) twice over time.

13. The elevator system (2) according to claim 1, further comprising;
at least one RFID tag (64) located in the hoistway (4) at at least one of the landings (8) and comprising information on the respective landing (8);
at least one RFID reader (66) attached to the at least one elevator car (6) and configured for reading information comprised in the at least one RFID tag.

14. A method of detecting and tracking the position of an elevator car (6) that is configured for traveling between a plurality of landings (8) along at least one guide member (14) in a hoistway (4) of an elevator system (2); wherein the method comprises:
detecting and tracking the position of the at least one elevator car (6) with a first accuracy, particularly at every position in the hoistway (4) that can be reached by the at least one elevator car (6); and
detecting and tracking the position of the at least one elevator car (6) with a second accuracy that is more accurate than the first accuracy when the reference point (R) of the at least one elevator car (6) is located in a fine tracking zone (50) that is defined in the vicinity of at least one of the landings (8).

15. The method according to claim 14, wherein the method further includes checking and/or recalibrating information on the position of the at least one elevator car (6) provided by coarsely detecting the position of the at least one elevator car (6) with the first accuracy based on information on the position of the at least one elevator car (6) provided by finely detecting the position of the at least one elevator car (6) with the second accuracy when the reference point (R) of the at least one elevator car (6) is located in a respective fine tracking zone (50) defined in the vicinity of at least one of the landings (8).
